(19) United States
(12) Patent Application Publication
(10) Pub. No.: US 2024/0243410 A1
(43) Pub. Date: Jul. 18, 2024

(54) Lightweight Battery Module Housing with Improved Rigidity and Battery Pack Including the Same

(71) Applicant: LG Energy Solution, Ltd., Seoul (KR)

(72) Inventors: Eun Ah Ju, Daejeon (KR); Sung Won Seo, Daejeon (KR); Hyeon Ki Yun, Daejeon (KR); Guenter Tannenberger, Pobenhausen (DE); Uwe Harasztosi, Neckarsulm (DE); Thomas Wassermann, Geisenfeld (DE)

(73) Assignee: LG Energy Solution, Ltd., Seoul (KR)

(21) Appl. No.: 18/562,648

(22) PCT Filed: Apr. 28, 2023
(86) PCT No.: PCT/KR2023/005854

§ 371 Date: Nov. 20, 2023

(30) Foreign Application Priority Data
May 10, 2022 (KR) 10-2022-0057074

(51) Int. Cl. H01M 50/258; H01M 50/224; H01M 50/242; H01M 50/264

(52) U.S. Cl. CPC H01M 50/258; H01M 50/224; H01M 50/242; H01M 50/264

(57) ABSTRACT

A battery module housing includes a receiving portion configured to allow a battery cell stack to be mounted therein. The receiving portion comprises a first side surface and a second side surface, a bolting portion configured to couple a plurality of battery module housings disposed adjacent to each other, and a buffer portion configured to absorb volume expansion of the battery cell stack, whereby a battery pack capable of accommodating an increase in volume of the battery cell stack while having reduced weight and minimized construction is provided.

### CROSS-REFERENCE TO RELATED APPLICATION

This application is a national phase entry under 35 U.S.C. § 371 of International Application No. PCT/KR2023/005854, filed on Apr. 28, 2023, which claims the benefit of priority to Korean Patent Application No. 10-2022-0057074 filed on May 10, 2022, the disclosures of which are incorporated herein by reference in their entirety.

### TECHNICAL FIELD

The present disclosure relates to a battery module housing and a battery pack including the same. More particularly, the present disclosure relates to a lightweight battery module housing with improved rigidity capable of relieving pressure due to expansion of a battery cell and allowing a plurality of battery modules to be coupled to each other and a battery pack including the same.

### BACKGROUND ART

Lithium secondary batteries, which are rechargeable and have high energy density, have attracted attention as a new energy source with environmentally-friendly characteristics not only because the lithium secondary batteries can drastically reduce the use of fossil fuels but also because the lithium secondary batteries do not generate by-products from the use of energy.

Lithium secondary batteries are in the limelight as an energy source for devices having high output and high energy density, such as electric vehicles, as well as wearable devices or portable devices.

In order to be used as an energy source with such high output and high energy density, a plurality of lithium secondary batteries is received in a housing so as to be configured in the form of a battery module and a battery pack.

Since an active material layer of the lithium secondary battery expands and contracts during the charging and discharging process, the volume of a battery cell increases and decreases, and change in the volume of the battery cell may cause deformation of the battery module and the battery pack. Therefore, a structure to buffer volume change of the battery cell is required.

In addition, various structural modifications have been made to omit or replace components, such as a crossbeam and a battery pack top plate, constituting a conventional battery pack in order to produce a battery pack having high energy density.

In connection therewith, Patent Document 1 discloses a battery module including a module housing having a square tubular shape forming an internal space configured to receive battery cells and fastening flanges extending in a horizontal direction from upper areas on opposite sides of the module housing.

The battery module of Patent Document 1 discloses a configuration for protecting the battery cells from external impact by attaching a shock absorber to an outer surface of a side part of the module housing; however, the shock absorber is a separate member from the module housing and requires coupling of the shock absorber to the module housing. During assembly of a battery pack, therefore, members, such as a rigid beam and a pack cover, are provided.

Patent Document 2 discloses a battery module comprising a U-shaped frame configured to receive a battery cell stack, the U-shaped frame having an open top, a top plate configured to cover the battery cell stack on the open top of the U-shaped frame, and a side portion having a depression inwardly recessed toward the battery cell stack.

In Patent Document 2, an elastic member configured to apply elastic force to the depression in a stacking direction of battery cells is included, whereby it is possible to absorb pressure caused by expansion of the battery cells.

However, the battery module of Patent Document 2 does not provide a structure for coupling a plurality of battery modules to each other and includes a separate elastic member provided inside the frame in order to absorb the expansion of the battery cells, whereby the size of the battery module increases by the volume of the elastic member.

Therefore, there is a need for a structure that allows a battery pack to be manufactured with a minimal configuration to increase energy density without increasing the volume of a battery module although a configuration to buffer volume change due to expansion of battery cells is included.

### PRIOR ART DOCUMENTS

(Patent Document 1) Korean Patent Application Publication No. 2020-0112246 (2020.10.05)
(Patent Document 2) Korean Patent Application Publication No. 2021-0053086 (2021.05.11)

### DISCLOSURE

### Technical Problem

The present disclosure has been made in view of the above problems, and it is an object of the present disclosure to provide a battery module housing capable of absorbing volume expansion of a battery cell, thereby inhibiting change in size of a battery module, and constituting a battery pack in which a plurality of battery modules is stably coupled to each other and a battery pack including the same.

### Technical Solution

A battery module housing according to the present disclosure to accomplish the above object includes a receiving portion configured to allow a battery cell stack to be mounted therein, the receiving portion comprising a first side surface and a second side surface, a bolting portion configured to couple a plurality of battery module housings disposed adjacent to each other, and a buffer portion configured to absorb volume expansion of the battery cell stack.

The bolting portion may be located at an upper end and a lower end of each of the first side surface and the second side surface.

The bolting portion may have a structure in which a through-hole is formed in a fastening portion, the through-hole extending perpendicularly to the first side surface and the second side surface.

The fastening portion may be disposed in an overall length direction of the receiving portion.

The buffer portion may have a structure in which a buffer structure projecting in an overall width direction parallel to an expansion direction of the battery cell stack is provided on at least one of the first side surface and the second side surface.

The buffer structure may include a cushion portion having a vertical sectional shape of a horseshoe.

The battery module housing may further comprise a guard outside the cushion portion.

The buffer structure may be disposed in the overall length direction of the receiving portion.

The thickness of each of the first side surface and the second side surface may be gradually decreased from a central part to an upper end and a lower end thereof.

The projecting height of the buffer portion may be less than or equal to the projecting height of the bolting portion.

The receiving portion may further include an upper surface and a lower surface, and each of the upper surface and a lower surface may have a hollow therein.

The receiving portion, the bolting portion, and the buffer portion may be manufactured by extrusion molding of a metal.

The present disclosure provides a battery pack configured such that battery modules are connected to each other in a horizontal direction, wherein each battery module includes the battery module housing.

In addition, the present disclosure may provide various combinations of the above constructions.

### Advantageous Effects

As is apparent from the above description, a battery module housing according to the present disclosure is capable of absorbing volume expansion of a battery cell stack through a buffer portion integrated with a receiving portion.

In addition, a bolting portion, which is a connection structure between a plurality of battery module housings, and a buffer portion, which is a volume expansion accommodation structure, are provided on a first side surface and a second side surface so as to project therefrom, whereby it is possible to minimize an increase in volume of the battery module housing.

In addition, the battery module housing is capable of replacing a battery pack housing when a battery pack is manufactured, whereby it is possible to minimize the number of parts of the battery pack.

### DESCRIPTION OF DRAWINGS

FIG. 1 is a perspective view of a battery module according to a first embodiment.

FIG. 2 is a front view of a battery module housing of FIG. 1.

FIG. 3 is a perspective view of a battery module according to a second embodiment.

FIG. 4 is a front view of a battery module housing of FIG. 3.

FIG. 5 is a perspective view showing the state in which battery modules, one of which is shown in FIG. 1, are disposed adjacent to each other.

FIG. 6 is a perspective view of a battery pack according to the present disclosure.

### BEST MODE

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

In addition, a description to embody elements through limitation or addition may be applied to all inventions, unless particularly restricted, and does not limit a specific invention.

Also, in the description of the invention and the claims of the present application, singular forms are intended to include plural forms unless mentioned otherwise.

Also, in the description of the invention and the claims of the present application, “or” includes “and” unless mentioned otherwise. Therefore, “including A or B” means three cases, namely, the case including A, the case including B, and the case including A and B.

Hereinafter, embodiments of the present invention will be described in detail with reference to the accompanying drawings.

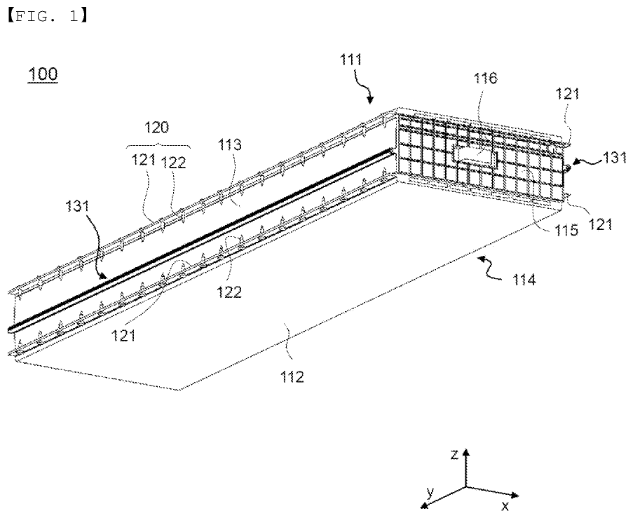

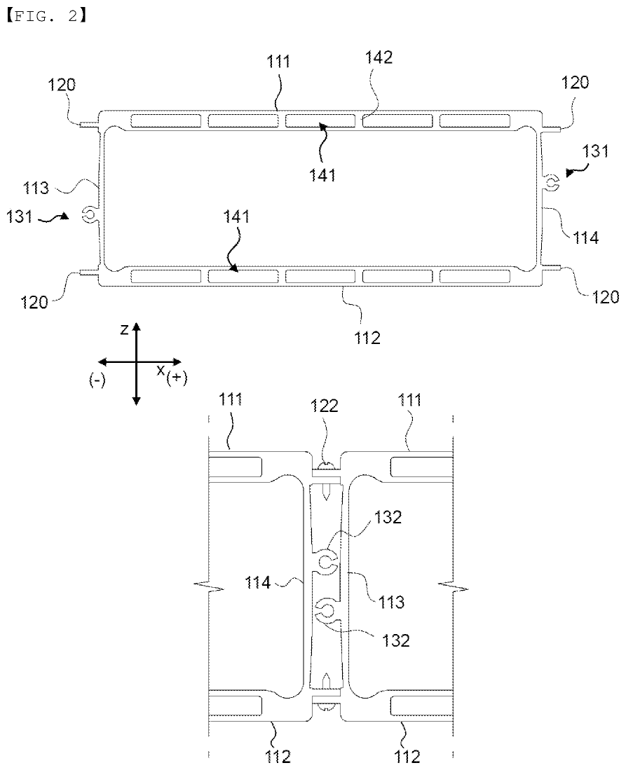

FIG. 1 is a perspective view of a battery module according to a first embodiment, and FIG. 2 is a front view of a battery module housing of FIG. 1.

Referring to FIGS. 1 and 2, the battery module 100 is configured such that a battery cell stack constituted by a plurality of battery cells disposed in tight contact with each other is received in a battery module housing, and the battery cell stack is disposed in a space defined between a first side surface 113 and a second side surface 114 of a receiving portion.

The battery module housing includes a receiving portion formed in the shape of a quadrangular prism monoframe configured such that an upper surface 111, a lower surface 112, a first side surface 113, and a second side surface 114 are vertically joined to each other, a bolting portion 120 for coupling between battery module housings that are disposed adjacent to each other, and a buffer portion 131 configured to absorb volume expansion of the battery cell stack.

An end plate 115 is added to each of opposite ends of the receiving portion in an overall length direction y in order to seal the receiving portion, and a module terminal 116 is located at the end plate 115 so as to project outwards therefrom.

The bolting portion 120 is a part configured to allow a screw 122 to be fastened thereto when a plurality of battery modules 100 is coupled to each other in a state of being disposed side by side in an overall width direction x, and is located at an upper end and a lower end of each of the first side surface 113 and the second side surface 114.

The bolting portion 120 is configured to have a structure in which a through-hole is formed in a fastening portion 121 extending perpendicularly to the first side surface 113 and the second side surface 114, and a nut may be fastened to the screw 122, which is inserted into the through-hole, whereby coupling between the battery modules 100 may be achieved.

Specifically, nut fastening is difficult in the state in which the battery modules 100 are located adjacent to each other and the fastening portions 121 overlap each other. After a nut is welded in advance to any one of the battery modules 100 disposed adjacent to each other such that the fastening portions 121 overlap each other, therefore, bolting engagement may be performed thereto, whereby the battery modules 100 may be coupled to each other.

Alternatively, a method of inserting a rivet stud/nut into the through-hole of the fastening portion 121 so as to be fastened or a method of inserting a flow drill screw 122 into the through-hole so as to be fastened may be used as a method of coupling the battery modules 100 to each other.

When coupling between the battery modules 100 is described in the following description, the screw 122 includes a screw 122 and a rivet that is inserted into the through-hole of the fastening portion 121, and the kind of the screw 122 is not restricted.

The fastening portion 121 is formed in the overall length direction y of the receiving portion. FIG. 1 shows a structure in which the fastening portion 121 is continuously formed in the overall length direction y. Unlike this, however, the fastening portion 121 may be discontinuously formed in the overall length direction y.

The battery cell stack may be configured such that a plurality of pouch-shaped battery cells is arranged in tight contact with each other, and the plurality of pouch-shaped battery cells may be disposed such that an electrode plane is parallel to a yz plane. At this time, a direction in which the volume of each of the pouch-shaped battery cells is expanded and reduced during charging and discharging of the battery module 100 is identical to the overall width direction x.

In the present disclosure, therefore, a buffer portion 131 is provided as a means configured to relieve pressure due to volume expansion of the pouch-shaped battery cells. Specifically, the buffer portion 131 may be configured to have a structure in which a buffer structure projecting in the overall width direction x is provided on at least one of the first side surface 113 and the second side surface 114 constituting opposite end surfaces of the battery module housing in the overall width direction x.

In FIGS. 1 and 2, therefore, one buffer portion 131 is formed at each of the first side surface 113 and the second side surface 114, and the buffer portion 131 of the first side surface 113 and the buffer portion 131 of the second side surface 114 are located at different positions in a z direction.

When two or more battery modules 100 are disposed in the overall width direction x and are connected to each other, therefore, the buffer portion 131 of the first side surface 113 and the buffer portion 131 of the second side surface 114 may not overlap each other and may be disposed at different positions.

The buffer structure includes a cushion portion 132 formed in the vertical sectional shape of a horseshoe. As shown in a lower part of FIG. 2, therefore, the battery module housings are coupled to each other by fastening using the screw 122 and the left battery module housing expands in a (+) x direction while the right battery module housing expands in a (−) x direction as the result of expansion of the battery cells, the buffer portion 131 is deformed such that the x-direction size of the buffer portion is decreased and the z-direction size of the buffer portion is increased. That is, the buffer portion 131 may serves as a cushion or a spring that absorbs the volume expansion of the battery module housing.

The buffer structure is formed in the overall length direction y of the receiving portion. FIG. 1 shows a structure in which the buffer portion 131 is continuously formed in the overall length direction y. Unlike this, however, the buffer portion 131 may be discontinuously formed in the overall length direction y.

In a concrete example, the thickness of each of the first side surface 113 and the second side surface 114 may be gradually decreased from a central part to an upper end and a lower end thereof in the z direction. In consideration of the fact that deformation of the battery module housing due to the volume expansion thereof occurs in the x direction and deformation of the central part in the z direction is greatest, the thickness of the central part in the z direction may be formed so as to be relatively large, whereby it is possible to minimize deformation of the battery module housing.

In the battery module housing according to the present disclosure, the bolting portion 120 is formed at each of the first surface 113 and the second surface 114, the buffer portion 131 is provided on at least one of the first surface 113 and the second surface 114, and the bolting portions 120 and the buffer portions 131 are disposed so as not to overlap each other at the first surface 113 and the second surface 114. Consequently, it is possible to form a structure capable of minimizing an increase in external size of the battery module housing even though both the structure for coupling between the battery modules 100 and the structure for relieving the volume expansion are included.

Meanwhile, the x-direction length of the buffer portion 131 is formed so as to be less than the x-direction length of the bolting portion 120. In the state in which two or more battery module housings are coupled to each other and the battery cells do not expand, therefore, the buffer portion 131 is spaced apart from the first side surface or the second side surface of the battery module housing adjacent thereto by a predetermined distance without contact therewith.

That is, the battery module housings are coupled in the state in which the battery cells do not expand, i.e. in the state in which no pressure is applied to the buffer portion 131, and when the battery cells expand, the first side surface or the second side surface of the battery module housing adjacent to the buffer portion starts to come into contact with the buffer portion, and the buffer portion may be pressed soon after.

In addition, although the first side surface 113 and the second side surface 114 expand by the x-direction length of the bolting portion 120, it is possible to prevent an increase in the size of all of the battery modules 100 in the overall width direction x in the state in which the plurality of battery modules is coupled to each other as the result of the screw being fastened to the bolting portion 120.

The battery module housing according to the present disclosure is configured to have a structure in which a hollow 141 is formed in each of the upper surface 111 and the lower surface 112, and therefore it is possible to reduce the weight of the battery module housing by the weight of the part removed as the result of forming the hollow. In addition, each of the upper surface 111 and the lower surface 112 is configured to have a structure in which partition walls 142 are provided in the thickness direction z and the hollow 141 is defined between the partition walls 142, whereby it is possible to secure rigidity of the battery module housing by the provision of the partition walls 142.

The battery module housing is configured to have an integrated structure manufactured by extrusion molding of metal, and therefore the receiving portion, the bolting portion, and the buffer portion may be integrated into a single body.

The metal may include aluminum, carbon steel, stainless steel, and an alloy thereof.

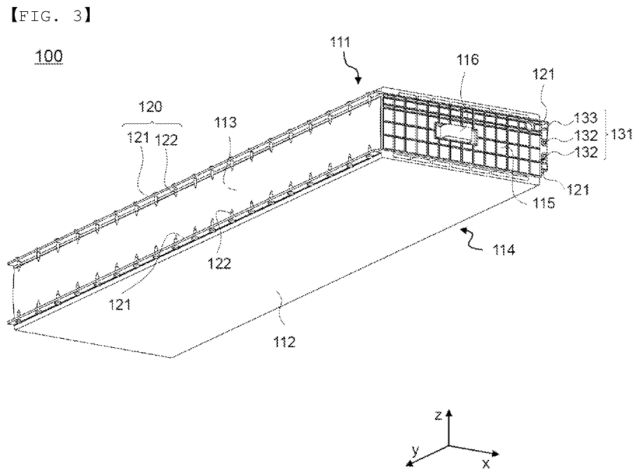

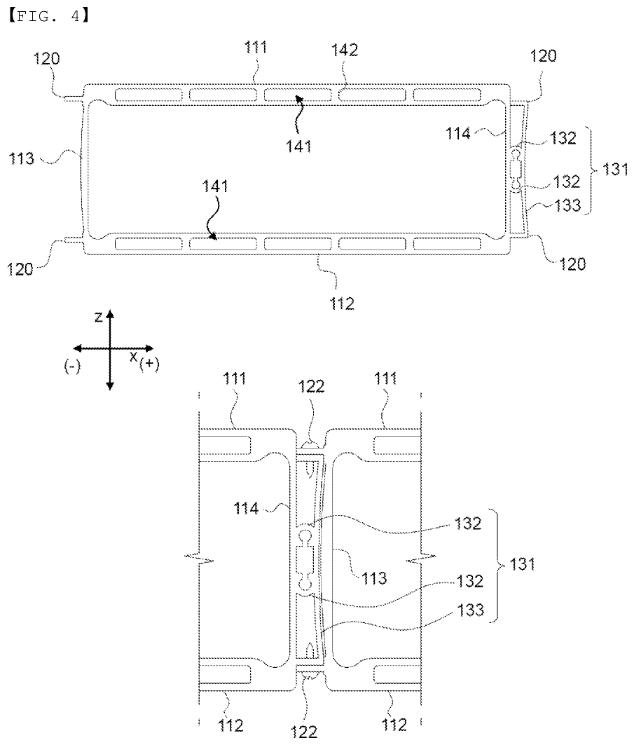

FIG. 3 is a perspective view of a battery module 100 according to a second embodiment, and FIG. 4 is a front view of a battery module housing of FIG. 3.

Referring to FIGS. 3 and 4, the battery module housing of the battery module 100 according to the second embodiment is different from the battery module housing according to the first embodiment in that a guard 133 is further provided outside a cushion portion 132 formed in the vertical sectional shape of a horseshoe constituting a buffer portion 131.

Also, in the battery module housing shown in FIGS. 3 and 4, no buffer portion 131 is formed at a first side surface 113, and the buffer portion 131 is formed only at a second side surface 114. The buffer portion 131 formed only at the second side surface 114 includes two cushion portions 132, each of which is formed in the vertical sectional shape of a horseshoe, and a guard 133. A receiving portion, the buffer portion 131 including the cushion portions 132 and the guard 133, and a bolting portion 120 are configured to have an integrated structure manufactured by extrusion molding of metal.

When two battery module housings are connected to each other by fastening using a screw 122, as shown in a lower part of FIG. 4, the second side surface 114 of the left battery module housing and the first side surface 113 of the right battery module housing are coupled to each other in a state of being disposed adjacent to each other, and the guard 133 of the second side surface 114 of the left battery module housing is coupled to the first side surface 113 of the right battery module housing in a state of being spaced apart therefrom. When the battery module housings expand in the x direction, therefore, the expanded volume may be accommodated in the buffer portion 131 and the space.

A description of the battery module 100 according to the first embodiment and the battery module housing may be equally applied to the other construction of the battery module 100 according to the second embodiment and the battery module housing.

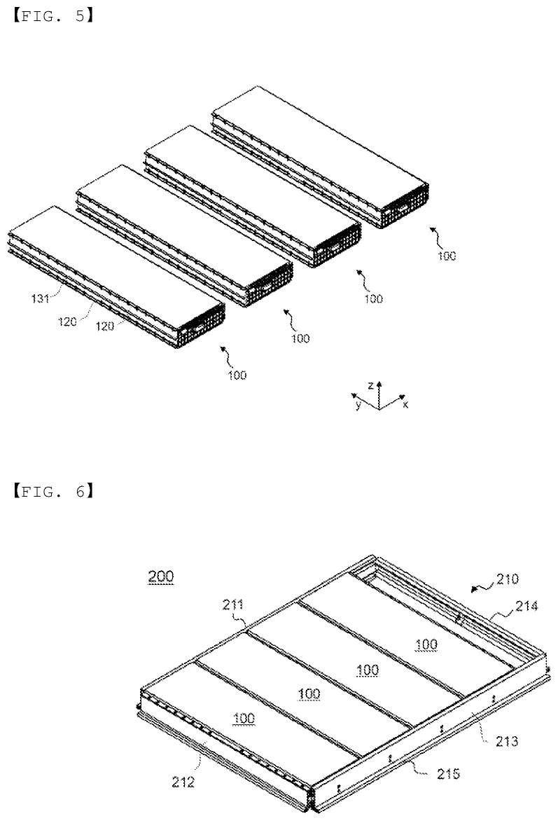

FIG. 5 is a perspective view showing the state in which battery modules 100, one of which is shown in FIG. 1, are disposed adjacent to each other.

Referring to FIG. 5, the battery modules 100, each of which includes the battery module housing, are disposed adjacent to each other in a horizontal direction x, and the screw may be fastened to the bolting portion 120 of the battery module housing, whereby it is possible to manufacture a battery pack including a plurality of battery modules 100 connected to each other. Since the battery modules 100 are connected to each other such that the buffer portion 131 is disposed between the first side surface and the second side surface of the battery modules 100, the volume of the battery modules expanded in the x direction may accommodated in the buffer portion 131.

FIG. 6 is a perspective view of a battery pack according to the present disclosure.

Referring to FIG. 6, the battery pack 200 has a structure in which an upper surface and a lower surface of each of battery module housings are exposed in the state in which a plurality of battery modules 100 is mounted in a battery pack frame 210.

The battery module housing according to the present disclosure has a structure in which a partition wall and a hollow are formed in each of the upper surface and the lower surface of the battery module housing, whereby rigidity of the battery module housing is improved, i.e. the strength of the battery module housing against external impact is improved. Consequently, the battery module housing may replace a top plate and a pack tray of the battery pack, and therefore no separate top plate and pack tray are necessary during assembly of the battery pack. In addition, when the battery modules 100 are coupled to each other via the bolting portion and the buffer portion constituted by the cushion portions and the guard, the bolting portion and the buffer portion may serve as a conventional battery pack crossbeam, and therefore it is also possible to omit a crossbeam from the battery pack according to the present disclosure.

The battery pack frame 210 may be constituted by a first member 211, a second member 212, a third member 213, and a fourth member 214 connected to each other so as to be perpendicular to each other, and the first member 211, the second member 212, the third member 213, and the fourth member 214 may be separate members configured to be detachably coupled to each other.

Meanwhile, a mounting portion 215 for mounting the battery pack in a device may be necessary, and the mounting portion 215 may be provided at a lower end of at least one of the first member 211, the second member 212, the third member 213, and the fourth member 214. Consequently, no separate part for mounting the battery pack in a device is necessary.

When the battery module housing according to the present disclosure is used, as described above, it is possible to accommodate deformation of a battery cell stack due to expansion thereof, to simply couple a plurality of battery modules 100 to each other, and to reduce the number of parts constituting the battery pack, whereby rigidity of the battery pack may be improved while the weight of the battery pack is reduced.

Those skilled in the art to which the present invention pertains will appreciate that various applications and modifications are possible within the category of the present invention based on the above description.

### DESCRIPTION OF REFERENCE NUMERALS

100: Battery module
111: Upper surface
112: Lower surface
113: First side surface
114: Second side surface
115: End plate
116: Module terminal
120: Bolting portion
121: Fastening portion
122: Screw
131: Buffer portion
132: Cushion portion
133: Guard
141: Hollow
142: Partition wall
200: Battery pack
210: Battery pack frame
211: First member
212: Second member
213: Third member
214: Fourth member
215: Mounting portion

1.-13. (canceled)

14. A battery cell stack housing comprising:
a receiving portion configured to allow a battery cell stack to be mounted therein, the receiving portion comprising a first side surface and a second side surface;
a bolting portion configured to couple a plurality of battery cell stack housings disposed adjacent to each other; and
a buffer portion configured to absorb volume expansion of the battery cell stack.

15. The battery cell stack housing according to claim 14, wherein the bolting portion is located at an upper end and a lower end of each of the first side surface and the second side surface.

16. The battery cell stack housing according to claim 15, wherein the bolting portion has a structure in which a through-hole is formed in a fastening portion, the through-hole extending perpendicularly to the first side surface and the second side surface.

17. The battery cell stack housing according to claim 16, wherein the fastening portion is disposed in an overall length direction of the receiving portion.

18. The battery cell stack housing according to claim 14, wherein the buffer portion has a structure in which a buffer structure projecting in an overall width direction parallel to an expansion direction of the battery cell stack is provided on at least one of the first side surface and the second side surface.

19. The battery cell stack housing according to claim 18, wherein the buffer structure comprises a cushion portion having a vertical sectional shape of a horseshoe.

20. The battery cell stack housing according to claim 19, wherein the battery cell stack housing further comprises a guard outside the cushion portion.

21. The battery cell stack housing according to claim 18, wherein the buffer structure is disposed in an overall length direction of the receiving portion.

22. The battery cell stack housing according to claim 14, wherein a thickness of each of the first side surface and the second side surface is gradually decreased from a central part to an upper end and a lower end thereof.

23. The battery cell stack housing according to claim 14, wherein a projecting height of the buffer portion is less than or equal to a projecting height of the bolting portion.

24. The battery cell stack housing according to claim 14, wherein:
the receiving portion further comprises an upper surface and a lower surface, and
each of the upper surface and a lower surface has a hollow therein.

25. The battery cell stack housing according to claim 14, wherein the receiving portion, the bolting portion, and the buffer portion are manufactured by extrusion molding of a metal.

26. A battery pack configured such that battery cell stack housings are connected to each other in a horizontal direction,
wherein each battery cell stack housing comprises the battery cell stack housing according to claim 14.
